(19) United States
(12) Patent Application Publication
(10) Pub. No.: US 2019/0139544 A1
(43) Pub. Date: May 9, 2019

(54) VOICE CONTROLLING METHOD AND SYSTEM

(71) Applicant: Institute for Information Industry, Taipei (TW)

(72) Inventors: Te-Cheng Chen, New Taipei City (TW); Yi-Chin Lee, New Taipei City (TW)

(21) Appl. No.: 15/832,724

(22) Filed: Dec. 5, 2017

(30) Foreign Application Priority Data
Nov. 3, 2017 (TW) 106138180

(51) Int. Cl. G10L 15/22; G10L 15/26; G10L 15/06; G10L 15/187; G10L 13/02; G10L 19/00; G06F 3/16; G06F 3/0481; G06N 3/02

(52) U.S. Cl. CPC G10L 15/22; G10L 15/26; G10L 15/063; G10L 15/187; G06F 1/26; G10L 19/0018; G06F 3/167; G06F 3/0481; G06N 3/02; G10L 13/02

(57) ABSTRACT

A voice controlling method and system are disclosed herein. The voice controlling method includes the following operations: inputting a voice and recognizing the voice to generate a sentence sample; generating at least one command keyword and at least one object keyword based on the sentence sample; performing encoding conversion according to an initial, a vowel, and a tone of the at least one object keyword and generating a vocabulary coding set; utilizing the vocabulary coding set and an encoding database to calculate a phonetic score and comparing the phonetic score and a threshold to generate at least one target vocabulary sample; comparing the at least one target vocabulary sample and a target vocabulary relation model to generate at least one audience information; and executing an operation corresponding to the at least one command keyword for the at least one audience information.

### RELATED APPLICATIONS

This application claims priority to Taiwan Application Serial Number 106138180, filed Nov. 3, 2017, the entirety of which is herein incorporated by reference.

### BACKGROUND

### Field of Invention

The present application relates to a voice controlling method and a system thereof. More particularly, the present application relates to a voice controlling method and system thereof for recognizing a specific term.

### Description of Related Art

Recently, speech recognition technology has matured (e.g., Siri or google speech recognition). Users are also using voice input or voice control functions when operating electronic devices such as mobile devices or personal computers. However, there are homophones and special terms in Chinese, such as names, place names, company names or abbreviations, etc., so that the speech recognition system may not be able to recognize words accurately or even accurately recognize meaning of words.

In the current speech recognition method, the voice recognition system would establish the user's voiceprint information and lexical database in advance, but this will cause the system being only used for a particular user. Moreover, if there are many similar pronunciations of contacts, it will cause the wrong recognition of the speech recognition system. Therefore, the user still needs to adjust the recognized words, and it not only affects the accuracy of the speech recognition system but also affects the user's operational convenience. Therefore, how to solve the problem of inaccurate recognition of speech recognition system in specific vocabularies is one of the problems to be improved in the art.

### SUMMARY

An aspect of the disclosure is to provide a voice controlling method which is suitable for an electronic apparatus. The voice controlling method includes: inputting a voice and recognizing the voice to generate a sentence sample; generating at least one command keyword and at least one object keyword based on the sentence sample to perform a common sentence training; performing encoding conversion according to an initial, a vowel, and a tone of the at least one object keyword, generating a vocabulary coding set; utilizing the vocabulary coding set and an encoding database to perform a phonetic score calculation to generate a phonetic score and comparing the phonetic score and a threshold to generate at least one target vocabulary sample; comparing the at least one target vocabulary sample and a target vocabulary relation model to generate at least one audience information; and executing an operation corresponding to the at least one command keyword for the at least one audience information.

Another aspect of the disclosure is to provide a voice controlling system. In accordance with one embodiment of the present disclosure, the voice controlling system includes: a sentence training module, an encoding module, a score module, a vocabulary sample comparison module and an operation execution module. The sentence training module configured for performing a common sentence training according to a sentence sample, generating at least one command keyword and at least one object keyword. The encoding module is coupled with the sentence training module and configured for performing encoding conversion according to an initial, a vowel, and a tone of the at least one object keyword, generating a vocabulary coding set. The score module is coupled with the encoding module and configured for utilizing the vocabulary coding set and a encoding database to perform a phonetic score calculation to generate a phonetic score and comparing the phonetic score and a threshold to generate at least one target vocabulary sample. The vocabulary sample comparison module is coupled with the score module and configured for comparing the at least one target vocabulary sample and a target vocabulary relation model to generate at least one audience information. The operation execution module is coupled with the vocabulary sample comparison module and configured for executing an operation corresponding to the at least one command keyword for the at least one audience information.

Based on aforesaid embodiments, the voice controlling method and system thereof are capable of improving the inaccurate recognition of speech recognition system in specific vocabularies. It mainly utilized the deep neural network algorithm to find out keywords of the input sentence, and then analyzed the relationship between the initial, vowel and tone of keywords. It is capable of recognizing specific vocabularies without having pre-established the user's voiceprint information and lexical database. The disclosure overcomes the limitation that the speech recognition system is not properly identified due to different accents.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic functional block diagram illustrating a voice controlling system according to an embodiment of the disclosure.

FIG. 2 is a schematic functional block diagram illustrating the processing unit according to an embodiment of the disclosure.

FIG. 3 is a schematic flow diagram illustrating a voice controlling method according to an embodiment of this disclosure.

FIG. 4 is a schematic flow diagram illustrating to establish the encoding database and a target vocabulary relation model according to an embodiment of this disclosure.

FIG. 5 is a schematic diagram illustrating the encoding database according to an embodiment of the disclosure.

FIG. 6 is a schematic diagram illustrating the target vocabulary relation model according to an embodiment of the disclosure.

FIG. 7 is a schematic flow diagram illustrating the step S340 according to an embodiment of the disclosure.

FIG. 8 is a schematic flow diagram illustrating the step S341 according to an embodiment of the disclosure.

FIG. 9A is a schematic diagram illustrating the phonetic score calculation according to an embodiment of the disclosure.

FIG. 9B is a schematic diagram illustrating the phonetic score calculation according to another embodiment of the disclosure.

FIG. 10 is a schematic diagram illustrating the user interaction with the voice controlling system according to another embodiment of the disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

As used herein, the term “initial” (also referred to as an “onset” or a “medial”) refers to an initial part of a syllable in the Chinese phonology. Generally, an initial may be a consonant.

As used herein, the term “vowel” refers to the remaining part of a syllable in the Chinese phonology by removing the initial of the syllable.

As used herein, the term “term” may be formed by one or more characters, and the term “character” may be formed by one or more symbols.

As used herein, the term “symbol” refers to a numeral symbol (e.g., “0”, “1”, “2”, “3”, “4” . . . ), an alphabetical symbol (e.g., “a”, “b”, “c”, . . . ) or any other symbol that is used in a phonetic system.

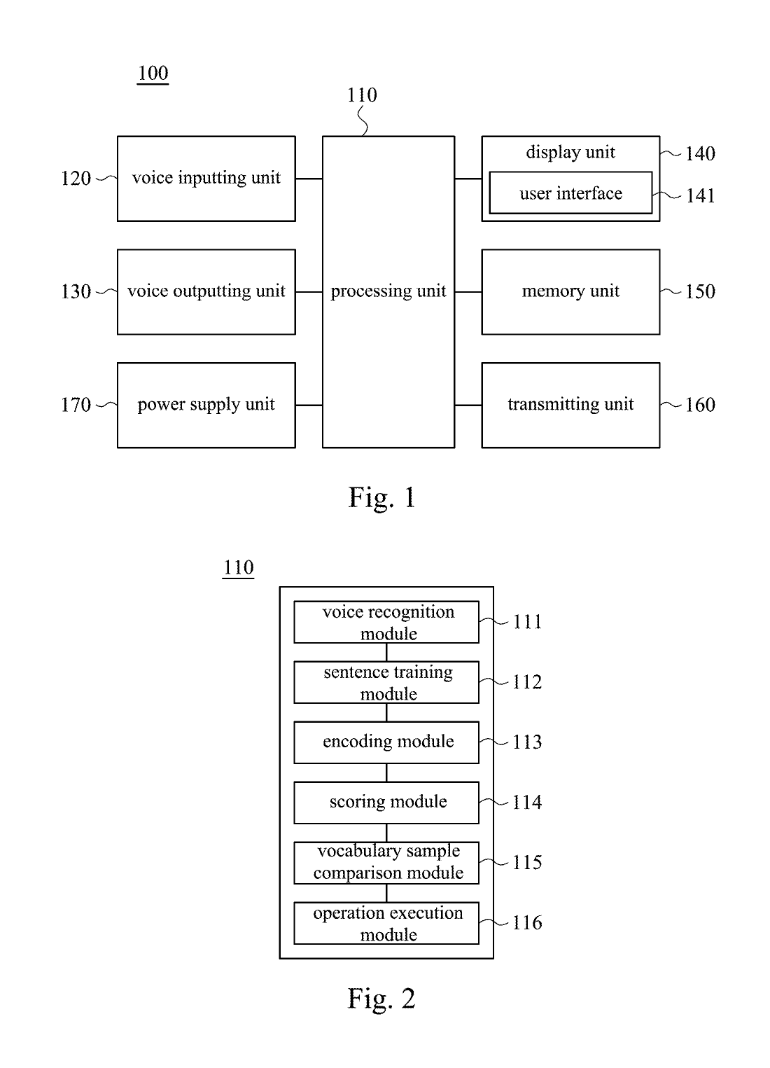

Reference is made to FIG. 1, which is a functional block diagram illustrating a voice controlling system 100 according to an embodiment of the disclosure. As shown in FIG. 1, the voice controlling system 100 includes a processing unit 110, a voice inputting unit 120, a voice outputting unit 130, a display unit 140, a memory unit 150, a transmitting unit 160, and a power supply unit 170. The processing unit 110 is electrically coupled with the voice inputting unit 120, the voice outputting unit 130, the display unit 140, the memory unit 150, the transmitting unit 160 and the power supply unit 170. The voice inputting unit 120 is configured for inputting a voice. The voice outputting unit 130 is configured for outputting the voice corresponding to the operation. The display unit 140 in some embodiments includes a user interface 141 and is configured for displaying the screen corresponding to the operation. The memory unit 150 is configured for storing a knowledge database, an encoding database and a phonetic rule database. The transmitting unit 160 is configured for transmitting the data via the internet. The power supply unit 170 is configured for supplying power to each unit of the voice controlling system 100.

In the embodiment, the processing unit 110 can be implemented by a micro controller, a microprocessor, a digital signal processor, an application specific integrated circuit (ASIC), a logical circuitry or any equivalent circuits of the processing unit 110. The voice inputting unit 120 can be implemented by a microphone. The voice outputting unit 130 can be implemented by a horn. The display unit 140 can be implemented by a LED displayer. The voice inputting unit 120, the voice outputting unit 130 and the display unit 140 can be implemented by any equivalent circuits. The memory unit 150 can be implemented by memory, hard disk, flash drive, memory card, etc. The transmitting unit 160 can be implemented by global system for mobile communication (GSM), personal handy-phone system (PHS), long term evolution (LTE), worldwide interoperability for microwave access (WiMAX), wireless fidelity (Wi-Fi), or Bluetooth, etc. The power supply unit 170 can be implemented by battery or any equivalent circuits of the power supply unit 170.

Reference is also made to FIG. 2, which is a schematic functional block diagram illustrating the processing unit 110 according to an embodiment of the disclosure. As shown in FIG. 2, the processing unit 110 includes a voice recognition module 111, a sentence training module 112, an encoding module 113, a scoring module 114, a vocabulary sample comparison module 115 and an operation execution module 116. The voice recognition module 111 is configured for recognizing the voice to generate the sentence sample. The sentence training module 112 is coupled with the voice recognition module 111 and configured for performing common sentence training according to a sentence sample and generating at least one command keyword and at least one object keyword. The encoding module 113 is coupled with the sentence training module 112 and configured for performing encoding conversion according to an initial, a vowel, and a tone of the at least one object keyword, generating a vocabulary coding set according to an encoding converted term. The scoring module 114 is coupled with the encoding module 113 and configured for utilizing the vocabulary coding set and a encoding database to perform a phonetic score calculation to generate a phonetic score and comparing the phonetic score and a threshold to generate at least one target vocabulary sample. The vocabulary sample comparison module 115 is coupled with the scoring module 114 and configured for comparing the at least one target vocabulary sample and a target vocabulary relation model to generate at least one audience information. The operation execution module 116 is coupled with the vocabulary sample comparison module 115 and configured for executing an operation corresponding to the at least one command keyword for the at least one audience information.

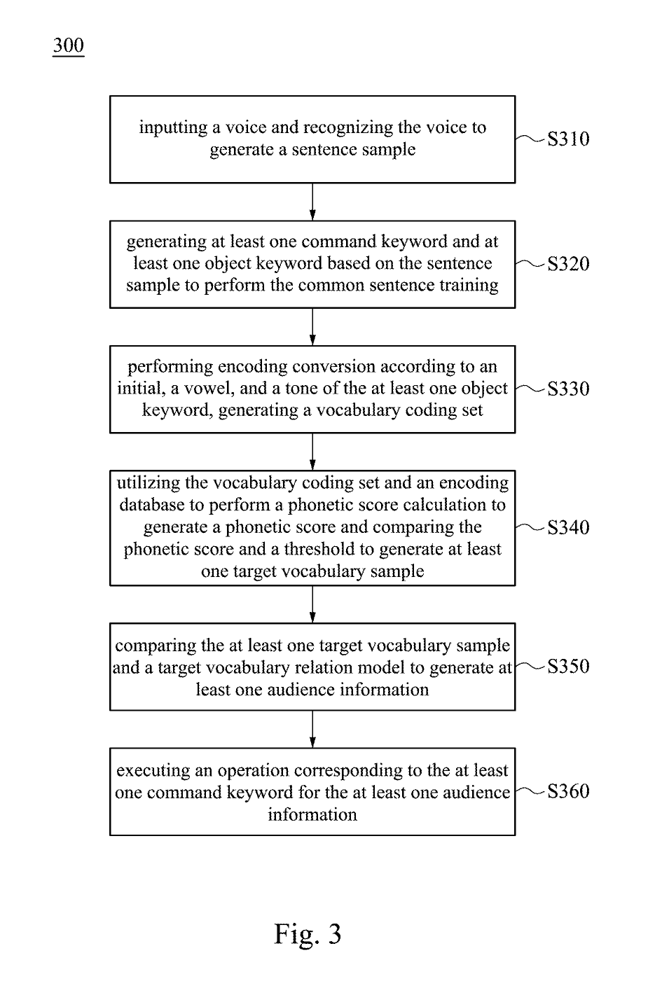

Reference is also made to FIG. 3, which is a schematic flow diagram illustrating a voice controlling method 300 according to an embodiment of this disclosure. As shown in FIG. 3, the voice controlling method 300 can be utilized to generate the audience information according to the target vocabulary sample and to execute an operation corresponding to the audience information. The voice controlling method 300 in the embodiment is suitable for the voice controlling system 100 as shown in FIGS. 1 and 2. The processing unit 110 is configured to adjust the inputting voice according to the voice controlling method 300 describe in the following steps.

To be convenient for explanation, reference is made to FIG. 1-FIG. 9B. As the embodiment shown in FIG. 3, the voice controlling method 300 firstly executes step S310 to input and recognize the voice to generate the sentence sample. In one embodiment, voice recognition module 111 of the processing unit 110 can recognize the input voice. The input voice may also be transmitted by the transmission unit 160 to the cloud speech recognition system via the internet. After the input voice is recognized by the cloud speech recognition system, the recognition result may be used as the sentence sample. For example, the cloud speech recognition system can be implemented by google speech recognition system.

Afterward, the voice controlling method 300 executes step S320 to generate at least one command keyword and at least one object keyword based on the sentence sample to perform the common sentence training. The common sentence training is performing the segmentation of words for the input voice, generating the common sentence training set according to the intention words and keywords, utilizing deep neural networks (DNN) to generate the DNN sentence model. The DNN sentence model is able to interpret the input voice to the command keywords and the object keywords. The voice controlling method in this disclosure is analyzed and processed for the object keywords.

Afterward, the voice controlling method 300 executes step S330 to perform encoding conversion according to an initial, a vowel, and a tone of the at least one object keyword, and to generate a vocabulary coding set according to an encoding converted term. The encoding conversion is able to use different phonetic encoding, such as Tongyong pinyin phonetic translation system, Chinese pinyin phonetic translation system and Romanization phonetic translation system, etc. The phonetic score calculation in the embodiment is mainly performed the Chinese pinyin phonetic translation system an exemplary demonstration, but the disclosure is not limited to this.

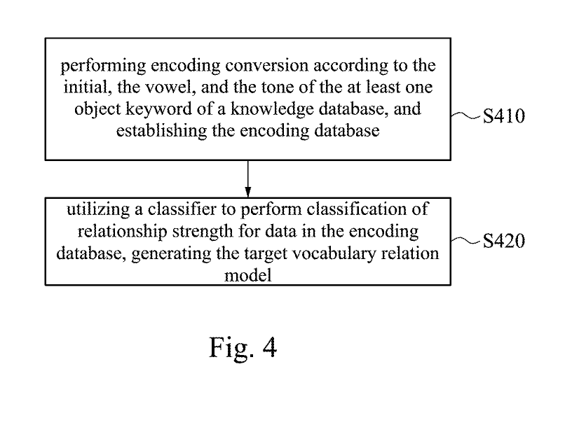

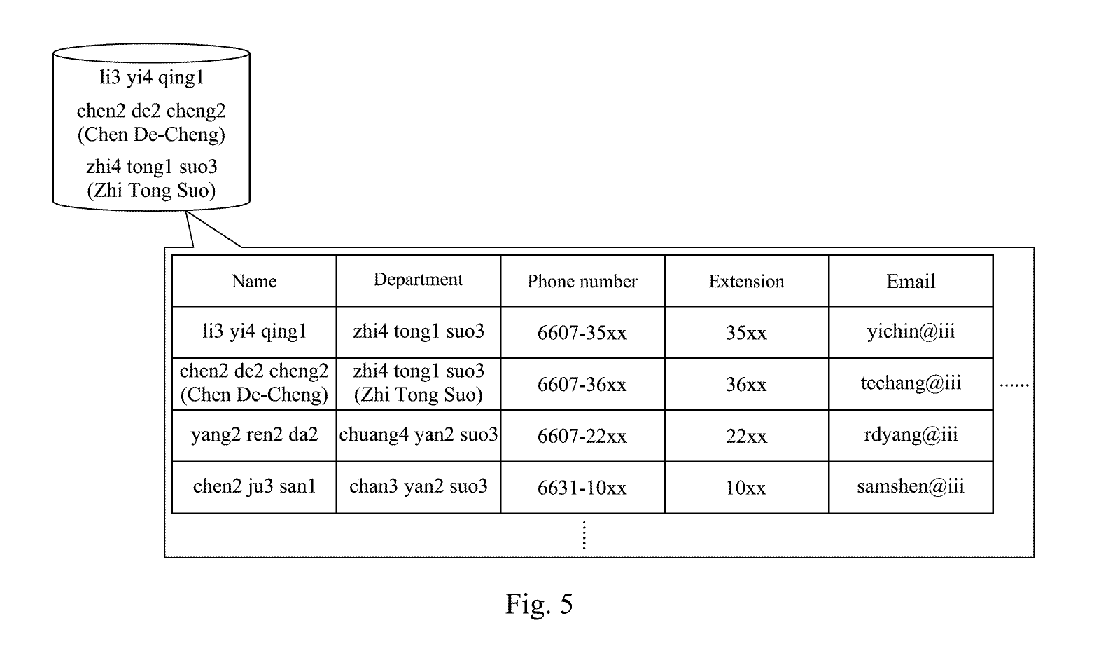

Before executing step S340, it is necessary to generate the encoding database. Reference is also made to FIG. 4, which is a flow diagram illustrating to establish the encoding database and a target vocabulary relation model according to an embodiment of this disclosure. As shown in FIG. 4, the voice controlling method 300 executes step S410 for performing encoding conversion according to the initial, the vowel, and the tone of the at least one object keyword of a knowledge database, and establishing the encoding database according to the encoding converted term. Reference is also made to FIG. 5, which is a schematic diagram illustrating the encoding database according to an embodiment of the disclosure. As shown in FIG. 5, the encoding database has multiple data fields, such as name, department, phone number and e-mail, etc., and then all of the Chinese vocabularies are converted into phonetic encoding type and stored in the encoding database. For example, the term “Chen De-Cheng” is expressed as chen2 de2 cheng2 and the term “Zhi Tong Suo” is expressed as zhi4 tong1 suo3. The number 1-4 is expressed as a tone in Chinese, it also can use number 0 to express as softly. The Chinese vocabularies are converted into phonetic encoding type according to phonetic rule, and the phonetic rule is stored in the phonetic rule database of the memory unit 150. Therefore, the disclosure is able to utilize different phonetic rule and to perform different encoding conversion.

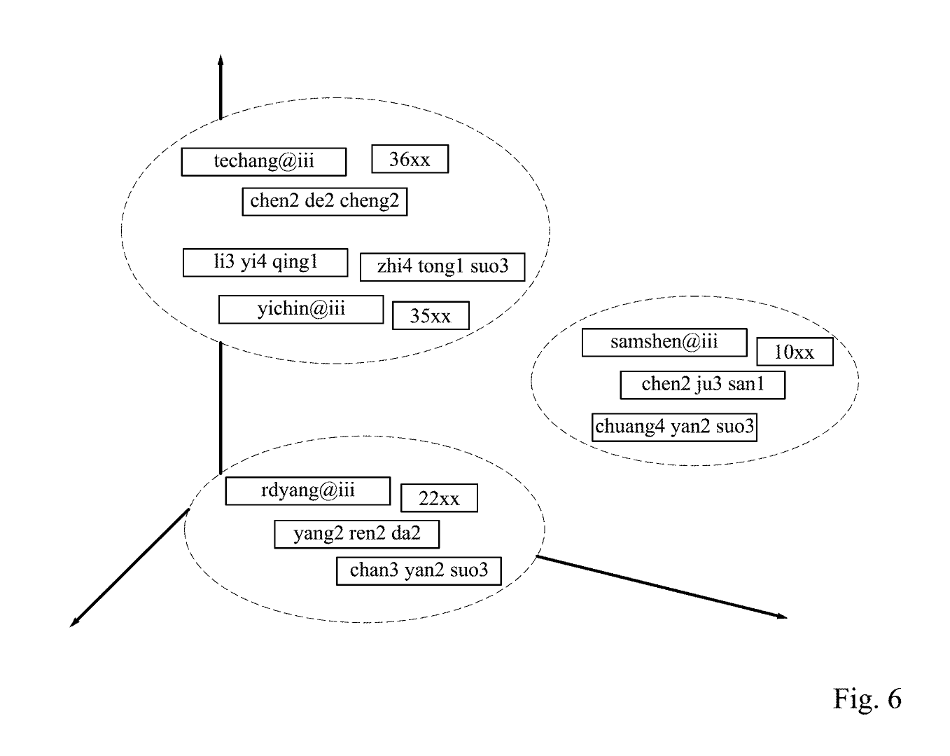

Afterward, the voice controlling method 300 executes step S420 for utilizing a classifier to perform classification of relationship strength for data in the encoding database, generating the target vocabulary relation model. The disclosure is utilized support vector machines (SVM) to classify the data in the encoding database. Firstly, the data in the encoding database is transformed into eigenvectors to build SVM. SVM is configured to map eigenvectors into high-dimensional feature planes to create an optimal hyperplane. SVM is mainly applicable for two-class tasks, but it is able to combine multiple SVMs to solve multi-class task. Reference is also made to FIG. 6, which is a schematic diagram illustrating the target vocabulary relation model according to an embodiment of the disclosure. As shown in FIG. 6, after the algorithm is calculated, the data in the encoding database with strong relationships will be classified together, to generate the target vocabulary relation model. The generation of the target vocabulary relation model in step S420 merely needs to be generated before the execution of step S350 according to the encoding database generated in step S410.

SVM maps eigenvectors to high-dimensional feature planes to create an optimal hyperplane. SVM is mainly applied to two-class problems, but multiple SVMs can be combined to solve multi-class problems.

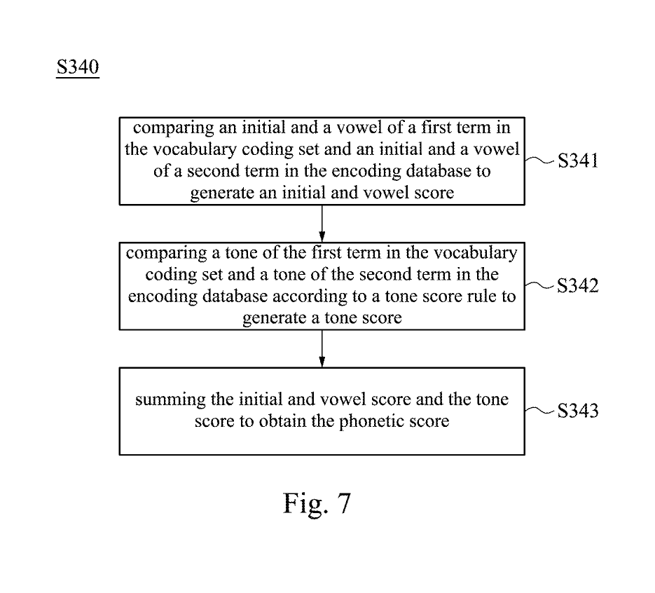

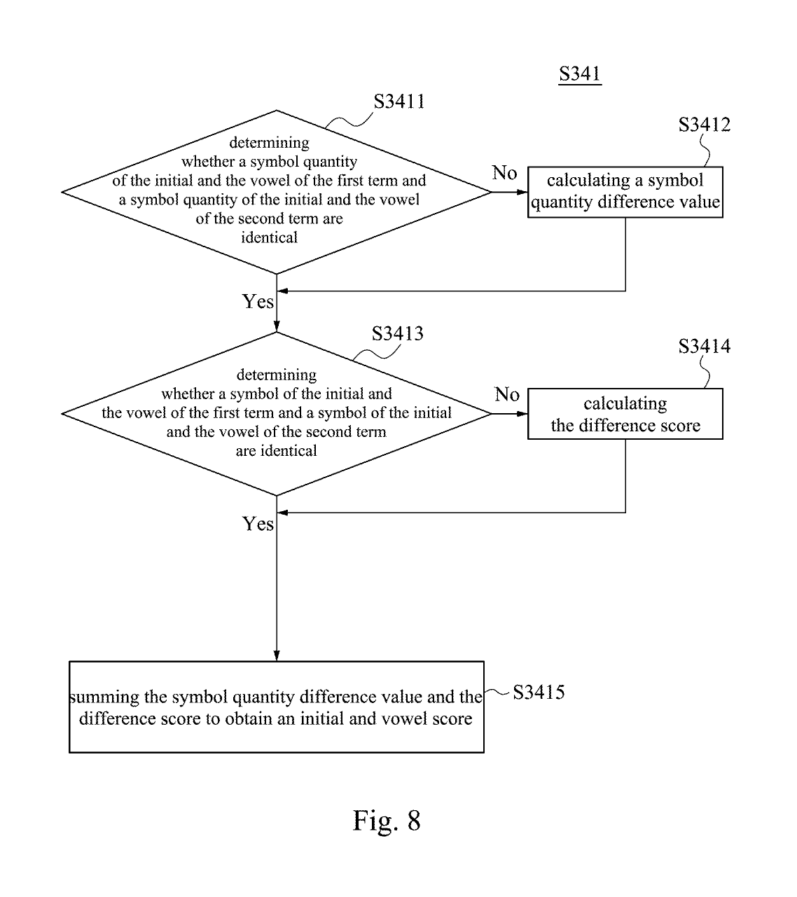

Reference is also made to FIG. 7, which is a schematic flow diagram illustrating the step S340 according to an embodiment of the disclosure. As shown in FIG. 7, the voice controlling method 300 executes step S341 for comparing an initial and a vowel of a first term in the vocabulary coding set and an initial and a vowel of a second term in the encoding database to generate an initial and vowel score. Reference is also made to FIG. 8, which is a flow diagram illustrating the step S341 according to an embodiment of the disclosure.

Afterward, the voice controlling method 300 executes step S3411 for determining whether a symbol quantity of the initial and the vowel of the first term with a symbol quantity of the initial and the vowel of the second term are identical. If step S3411 determines whether the symbol quantity of the initial and the vowel of the first term does not match a symbol quantity of the initial and the vowel of the second term, the voice controlling method 300 executes step S3412 for calculating a symbol quantity difference value between the symbol quantity of the initial and the vowel of the first term and the symbol quantity of the initial and the vowel of the second term.

If step S3411 determines that the symbol quantity of the initial and the vowel of the first term matches the symbol quantity of the initial and the vowel of the second term, the voice controlling method 300 executes step S3413 for determining whether a symbol of the initial and the vowel of the first term and a symbol of the initial and the vowel of the second term are identical or not. If step S3413 determines that the symbol of the initial and the vowel of the first term does not match the symbol of the initial and the vowel of the second term, the voice controlling method 300 executes step S3414 for calculating the difference score.

If step S3413 determines that the symbol of the initial and the vowel of the first term matches the symbol of the initial and the vowel of the second term, the voice controlling method 300 executes step S3415 for summing the symbol quantity difference value and the difference score to obtain an initial and vowel score.

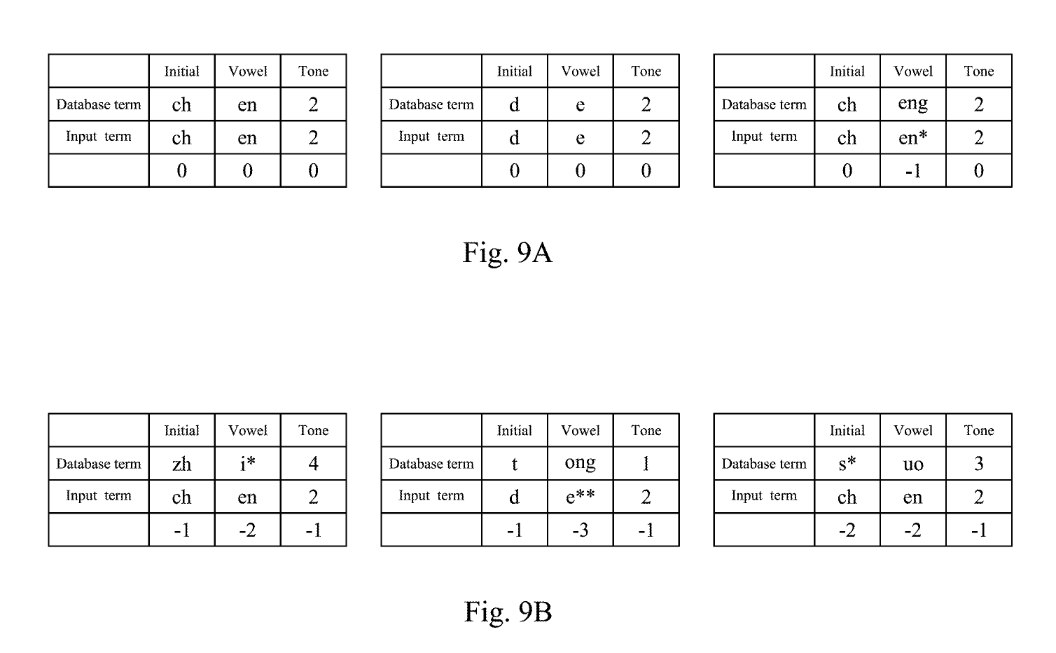

Reference is also made to FIG. 9A and FIG. 9B. FIG. 9A is a schematic diagram illustrating the phonetic score calculation according to an embodiment of the disclosure. FIG. 9B is a schematic diagram illustrating the phonetic score calculation according to another embodiment of the disclosure. For example, as shown in FIG. 9A, the input term includes: chen2 de2 chen2 ( [symbol] ), and database term includes: chen2 de2 cheng2 ( [symbol] ). Firstly, step S3411 determines whether the symbol quantity of the initial and the vowel of the input term with the symbol quantity of the initial and the vowel of the database term are identical. In this embodiment, the symbol quantity of the vowel (en) of the character “chen” is different from the symbol quantity of the vowel (eng) of the character “cheng”, so a symbol quantity difference value can be calculated and is expressed as special symbol (*) (step S3412). The symbol quantity difference value is calculated as −1 points, the vowel “en” and the vowel “eng” have the symbol quantity difference of one symbol. Secondly, step S3413 determines that the symbol of the initial and the vowel of the input term matches the symbol of the initial and the vowel of the database term or not. In this case, the symbol of the initial and the symbol of the vowel of the input term matches the symbol of the initial and the symbol of the vowel of the database term, so the difference score would not be calculated. Finally, step S3415 sums the symbol quantity difference value, and the difference score to obtain the initial and vowel score. The initial and vowel score of the input term (chen2 de2 chen2) and the database term (chen2 de2 cheng2) are −1+0=−1 point.

As shown in FIG. 9B, the input term includes: chen2 de2 chen2 ( [symbol] ), and the database term includes: zhi4 tong1 suo3 ( [symbol] ). In this embodiment, the symbol quantity of the vowel (en) of the character “chen” is different from the symbol quantity of the vowel (i) of the character “zhi”, and then the symbol quantity difference value is calculated as −1 point. The symbol quantity of vowel (e) of the character “de” is different from the symbol quantity of the vowel (ong) of the character “tong”, and then the symbol quantity difference value is calculated as −2 points. The symbol quantity of the initial (ch) of the character “chen” is different from the symbol quantity of the initial (s) of the character “suo”, and then the symbol quantity difference value is calculated as −1 point. Therefore, after the comparison of symbol quantity, the sum of the symbol quantity difference value accumulates to −4 points. The Initial and the vowel that have differences in the symbol quantity are expressed as special symbol (*), and this represents the difference of 4 symbols in the symbol quantity between the input term and the database term. Afterward, step S3413 compares the symbol of the initial and the vowel of the input term with the symbol of the initial and the vowel of the database term. In this case, the symbol of the initial (ch) of the character “chen” is different from the symbol of the initial (zh) of the character “zhi”. Since there is one symbol difference (symbol “c” and symbol “z”) between the initial “ch” and the initial “zh”, therefore the difference score of the initial is calculated as −1 point. The symbol of vowel (en) of the character “chen” is different from the symbol of the vowel (i) of the character “zhi”. There is one symbol difference (symbol “e” and symbol “i”) between the vowel “en” and the vowel “i”, therefore the difference score of vowel is calculated as −1 point. The symbol of the initial (d) of the character “de” is different from the symbol of the initial (t) of the character “tong”. There is one symbol difference (symbol “d” and symbol “t”) between the initial “d” and the initial “t”, therefore the difference score of initial is calculated as −1 point. The symbol of the vowel (e) of the character “de” is different from the symbol of vowel (ong) of the character “tong”. There is one symbol difference (symbol “e” and symbol “o”) between the vowel “e” and the vowel “ong”, and therefore the difference score of vowel is calculated as −1 point. The symbol of the initial (ch) of the character “chen” is different from the symbol of the initial (s) of the character “suo”, and there is one symbol difference (symbol “c” and symbol “s”) between the initial “ch” and the initial “s”, therefore the difference score of initial is calculated as −1 point. The symbols of the vowel (en) of the character “chen” is different from the symbols of the vowel (uo) of the character “suo”, and there are two symbol differences (symbols “en” and symbols “uo”) between the vowel “en” and the vowel “uo”, therefore the difference score of vowel is calculated as −2 point. Therefore, after the comparison of vocabulary character, the difference score of initial accumulates to −3 points, and the difference score of vowel accumulates to −4 points. The difference score accumulates to −7 points. Finally, the initial and vowel scores of the input term (zhi4 tong1 suo3) and the database term (chen2 de2 chen2) are summed as −4+−7=−11 point.

As shown in FIG. 7, the voice controlling method 300 executes step S342 for comparing the tone of the first term in the vocabulary coding set and the tone of the second term in the encoding database according to a tone score rule to generate a tone score. Reference is also made to Table 1, the tone score rule is shown in Table 1:

database term

| | 1 tone | 2 tone | 3 tone | 4 tone |
|---|---|---|---|---|
| input term | scale | scale | scale | scale |
| 1 tone scale | 0 | −1 | −1 | −2 |
| 2 tone scale | −1 | 0 | −1 | −1 |
| 3 tone scale | −1 | −1 | 0 | −1 |
| 4 tone scale | −2 | −1 | −1 | 0 |

According to the tone score rule in Table 1, the rule can be applied to this embodiments as shown in FIG. 9A and FIG. 9B. As shown in FIG. 9A, the input term includes chen2 de2 chen2 ( [symbol] ), and the database term includes chen2 de2 cheng2 ( [symbol] ). The tone of the character “chen2” is same as the tone of the character “chen2”, so as to calculate the tone score is 0 point, and the tone of the character “de2” is same as the tone of the character “de2”, so as to calculate the tone score is 0 point, and the tone of the character “chen2” is same as the character “cheng2” of tone, so as to calculate the tone score is 0 point. Afterward, the comparison of tone, the tone of the input term matches the tone of the database term, so the tone score is 0 point. As shown in FIG. 9B, the input term includes zhi4 tong1 suo3 ( [symbol] ), and the database term includes chen2 de2 chen2 ( [symbol] ). The tone of the character “zhi4” is different from the tone of the character “chen2”, after checking the Table 1, so the tone score is −1 point, and the tone of the character “tong1” is different from the tone of the character “de2”, after checking the Table 1, so the tone score is −1 point, and the tone of the character “suo3” is different from the tone of the character “chen2”, after checking the Table 1, so the tone score is −1 point. Finally, the tone scores of the input term (chen2 de2 chen2) and the database term (zhi4 tong1 suo3) word are summed as −3 point.

As shown in FIG. 7, the voice controlling method 300 executes step S343 for summing the initial and vowel scores and the tone score to obtain the phonetic score. Based on aforesaid embodiments, the phonetic score of the input term (chen2 de2 chen2) and the database term (chen2 de2 cheng2) are −1+0=−1 point, and the phonetic score of the input term (zhi4 tong1 suo3) and the database term (chen2 de2 cheng2) are −11+−3=−14 point.

Afterward, the voice controlling method 300 further executes the step S340 of comparing aforesaid phonetic score and a threshold to generate at least one target vocabulary sample. The threshold can be set by different situations. For example, if the threshold is set as the maximum value of the phonetic score, which will select the most suitable database term. In aforesaid embodiments, the comparison result between the input term (chen2 de2 chen2) and the database term (chen2 de2 cheng2) will be selected, so the database term (chen2 de2 cheng2) can be found as the target vocabulary sample. In addition, the selection of threshold is not limited to be the maximum value of the phonetic score. It is able to select the first and second values of the phonetic score, or set a value greater than the value of the phonetic score will be as the target vocabulary sample.

As shown in FIG. 3 and FIG. 6, the voice controlling method 300 further executes the step S350 of comparing the at least one target vocabulary sample and a target vocabulary relation model to generate at least one audience information. In aforesaid embodiments, the target vocabulary sample (chen2 de2 cheng2) is compared with the target vocabulary relation model, and it is able to find the related information of the target vocabulary sample (chen2 de2 cheng2), such as the phone number (e.g. 6607-36xx), the email address (yichin@iii) or department, etc.

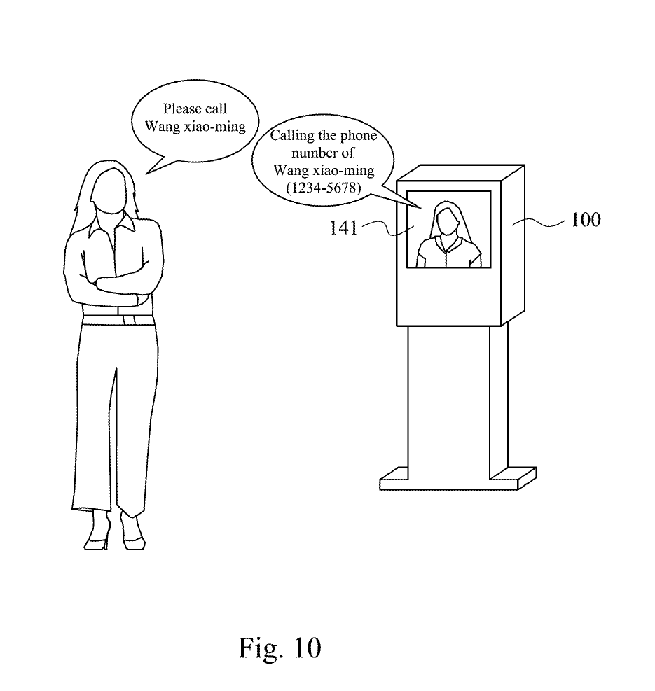

Afterward, the voice controlling method 300 further executes the step S360 of executing an operation corresponding to the at least one command keyword for the at least one audience information. Reference is also made to FIG. 10, which is a schematic diagram illustrating the user interaction with the voice controlling system according to another embodiment of the disclosure. As shown in FIG. 10, the user is talking to the voice controlling system 100. After the voice controlling system 100 interprets the voice, the voice controlling system 100 is able to execute the operation corresponding the user's command. In the FIG. 10 the user said that please call Wang xiao-ming, the voice controlling system 100 is interpreting the command, finding the phone number of Wang xiao-ming, and calling to Wang xiao-ming.

In other embodiments, if the voice controlling system 100 can have more than two sets of keywords for identification and search, it is able to generate more accurate results. For example, user can ask questions like that I want to take the package to Wang xiao-ming in the management department, may I ask him? The object keywords are “management department” and “Wang xiao-ming”, and the voice controlling system 100 is able to find the related information of “management department” and “Wang xiao-ming”, such as the phone number, email or department, etc.

In other embodiments, if the voice controlling system 100 merely has single set of keywords for identification and search, it may find more than one target vocabulary sample. For example, if there is only one set of object keywords of “Wang xiao-ming”, there may be the situations of Wang Xiaoming from different departments. In this case, it is able to add new keywords to search again or the voice controlling system 100 is able to list multiple audience information of “Wang Xiaoming” for the user to select. Of course, it is able to utilize the keywords which are the most often used to perform the further operation automatically. For example, if Wang Xiaoming in the administration department is most often used as the object keywords, the voice controlling system 100 is able to help user directly contact Wang Xiaoming in the administration according to the common list.

Based on aforesaid embodiments, the voice controlling method and system thereof are capable of improving the inaccurate recognition of speech recognition system in specific vocabularies. It mainly utilized the deep neural network algorithm to find out keywords of the input sentence, analyzed the relationship between the initial, vowel and tone of keywords, and then performed the operation according to the related information. It is capable of recognizing specific vocabularies without establishing the user's voiceprint information and lexical database in advance. The disclosure overcomes the limitation that the speech recognition system is not properly identified due to different accents

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A voice controlling method, comprising:
inputting a voice and recognizing the voice to generate a sentence sample;
generating at least one command keyword and at least one object keyword based on the sentence sample to perform a common sentence training;
performing encoding conversion according to an initial, a vowel, and a tone of the at least one object keyword, generating a vocabulary coding set;
utilizing the vocabulary coding set and an encoding database to perform a phonetic score calculation to generate a phonetic score and comparing the phonetic score and a threshold to generate at least one target vocabulary sample;
comparing the at least one target vocabulary sample and a target vocabulary relation model to generate at least one audience information; and
executing an operation corresponding to the at least one command keyword for the at least one audience information.

2. The voice controlling method of claim 1, further comprising:
performing encoding conversion according to the initial, the vowel, and the tone of the at least one object keyword of a knowledge database, and establishing the encoding database; and
utilizing a classifier to perform classification of relationship strength for data in the encoding database, generating the target vocabulary relation model.

3. The voice controlling method of claim 1, wherein the phonetic score calculation further comprising:
comparing an initial and a vowel of a first term in the vocabulary coding set and an initial and a vowel of a second term in the encoding database to generate an initial and vowel score;
comparing a tone of the first term in the vocabulary coding set and a tone of the second term in the encoding database according to a tone score rule to generate a tone score; and
summing the initial and vowel score and the tone score to obtain the phonetic score.

4. The voice controlling method of claim 3, wherein comparing the initial and the vowel of the first term and the initial and the vowel of the second term further comprising:
if a symbol quantity of the initial of the first term matches a symbol quantity of the initial of the second term, determining whether a symbol of the initial of the first term and a symbol of the initial of the second term are identical, if not, calculating a first score;
if the symbol quantity of the initial of the first term does not match the symbol quantity of the initial of the second term, calculating a first symbol quantity difference value, and determining whether the symbol of the initial of the first term and the symbol of the initial of the second term are identical, if not, calculating the first score;
if the symbol quantity of the vowel of the first term matches a symbol quantity of the vowel of the second term, determining whether the symbol of the vowel of the first term and the symbol of the vowel of the second term are identical, if not, calculating a second score;
if the symbol quantity of the vowel of the first term does not matches the symbol quantity of the vowel of the second term, calculating a second symbol quantity difference value, and determining whether the symbol of the vowel of the first term and the symbol of the vowel of the second term are identical, if not, calculating the second score; and
summing the first symbol quantity difference value, the second symbol quantity difference value, the first score, and the second score to obtain the initial and vowel score.

5. The voice controlling method of claim 3, wherein the tone score rule further comprises:
if the tone of the first term is different from the tone of the second term, calculating the tone score.

6. The voice controlling method of claim 1, wherein the common sentence training is utilize a deep neural network to generate the at least one command keyword and the at least one object keyword.

7. A voice controlling system, the voice controlling system having a processing unit, the processing unit comprising:
a sentence training module configured for performing a common sentence training according to a sentence sample, generating at least one command keyword and at least one object keyword;
an encoding module coupled with the sentence training module and configured for performing encoding conversion according to an initial, a vowel, and a tone of the at least one object keyword, generating a vocabulary coding set;
a scoring module coupled with the encoding module and configured for utilizing the vocabulary coding set and an encoding database to perform a phonetic score calculation to generate a phonetic score and comparing the phonetic score and a threshold to generate at least one target vocabulary sample;
a vocabulary sample comparison module coupled with the score module and configured for comparing the at least one target vocabulary sample and a target vocabulary relation model to generate at least one audience information; and
an operation execution module coupled with the vocabulary sample comparison module and configured for executing an operation corresponding to the at least one command keyword for the at least one audience information.

8. The voice controlling system of claim 7, wherein the processing unit further comprises:
a voice recognition module configured for recognizing the voice to generate the sentence sample.

9. The voice controlling system of claim 7, wherein the encoding database is coupled with the encoding module and the scoring module for utilizing the encoding module to perform encoding conversion according to the initial, the vowel, and the tone of the at least one object keyword of a knowledge database, and establishing the encoding database.

10. The voice controlling system of claim 7, wherein the target vocabulary relation model is coupled with the encoding database and the vocabulary sample comparison module for utilizing a classifier to perform classification of relationship strength for data in the encoding database, and generating the target vocabulary relation model.

11. The voice controlling system of claim 7, wherein the phonetic score calculation comprises the following operations:
comparing an initial and a vowel of a first term in the vocabulary coding set and an initial and a vowel of a second term in the encoding database to generate an initial and vowel score;
comparing a tone of the first term in the vocabulary coding set and a tone of the second term in the encoding database according to a tone score rule to generate a tone score; and
summing the initial and vowel score and the tone score to obtain the phonetic score.

12. The voice controlling system of claim 11, wherein comparing the initial and the vowel of the first term and the second term further comprises:
if a symbol quantity of the initial of the first term matches a symbol quantity of the initial of the second term, determining whether a symbol of the initial of the first term and a symbol of the initial of the second term are identical, if not, calculating a first score;
if the symbol quantity of the initial of the first term does not match the symbol quantity of the initial of the second term, calculating a first symbol quantity difference value, and determining whether the symbol of the initial of the first term and the symbol of initial of the second term are identical, if not, calculating the first score;
if the symbol quantity of the vowel of the first term matches the symbol quantity of the vowel of the second term, determining whether the symbol of the vowel of the first term and the symbol of the vowel of the second term are identical, if not, calculating a second score;
if a symbol quantity of the vowel of the first term does not match the symbol quantity of the vowel of the second term, calculating a second symbol quantity difference value, and determining whether the symbol of the vowel of the first term and the symbol of the vowel of the second term are identical, if not, calculating the second score; and
summing the first symbol quantity difference value, the second symbol quantity difference value, the first score, and the second score to obtain the initial and vowel score.

13. The voice controlling system of claim 11, wherein the tone score rule further comprises the following operations:
if the tone of the first term is different from the tone of the second term, calculating the tone score.

14. The voice controlling system of claim 7, wherein the common sentence training is utilize a deep neural network to generate the at least one command keyword and the at least one object keyword.

15. The voice controlling system of claim 7, further comprising:
a voice inputting unit electrically coupled with the processing unit and configured for inputting a voice;
a memory unit electrically coupled with the processing unit and being configured for storing a knowledge database and the encoding database;
a display unit electrically coupled with the processing unit and configured for displaying a screen corresponding to the operation; and
a voice outputting unit electrically coupled with the processing unit and configured for outputting the voice corresponding to the operation.

16. The voice controlling system of claim 15, wherein the display unit further comprises:
a user interface configured for displaying the screen corresponding to the operation.

17. The voice controlling system of claim 15, wherein the voice inputting unit comprises a microphone.

18. The voice controlling system of claim 15, wherein the voice outputting unit comprises a speaker.

19. The voice controlling system of claim 7, further comprising:
a transmitting unit electrically coupled with the processing unit and configured for transmitting a voice to a voice recognition system and receiving the sentence sample recognized by the voice recognition system.

20. The voice controlling system of claim 7, further comprising:
a power supply unit electrically coupled with the processing unit and configured for supplying power to the processing unit.
